(19) United States
(12) Patent Application Publication
(10) Pub. No.: US 2012/0263952 A1
(43) Pub. Date: Oct. 18, 2012

(54) PRETREATMENT METHOD FOR DYEING ULTRAHIGH MOLECULAR WEIGHT POLYETHYLENE YARN

(76) Inventors: Yong Gun KIM, (US); Hyun Seo Kang, (US)

(21) Appl. No.: 13/448,083

(22) Filed: Apr. 16, 2012

(30) Foreign Application Priority Data
Oct. 16, 2009 (KR) 10-2009-0098949

(51) Int. Cl. D02G 3/22; B05D 7/24

(52) U.S. Cl. 428/400; 427/222

(57) ABSTRACT

The present invention relates to a method of pre-treating an ultra-high molecular weight polyethylene yarn before dyeing. The method of pre-treating an ultra-high molecular weight polyethylene yarn before dyeing includes the steps of: applying a lubricant onto the surface of an ultra-high molecular weight polyethylene yarn; and passing the ultra-high molecular weight polyethylene yarn through a blowing tube and simultaneously blowing compressed air onto the surface of the ultra-high molecular weight polyethylene yarn.

### TECHNICAL FIELD

The present invention relates to a method of pretreating an ultra-high molecular weight polyethylene yarn before dyeing, in which the ultra-high molecular weight polyethylene yarn having high chemical resistance can be dyed with a general dye by physical treatment.

### BACKGROUND ART

High-density polyethylene having a weight-average molecular weight of about a million is referred to as “ultra-high molecular weight polyethylene (UHMW-PE)”, and is generally known as “UPE”.

Ultra-high molecular weight polyethylene is generally used to manufacture goods requiring high wear resistance, high impact resistance and low friction coefficient, such as guide rails, chains, conveyor belts, rollers and the like, because it is a thermoplastic polymer having very high wear resistance and impact resistance.

Such ultra-high molecular weight polyethylene is generally used also to manufacture bulletproof clothes, industrial gloves and the like by forming it into a fiber.

Meanwhile, ultra-high molecular weight polyethylene is known to have chemical resistance sufficiently strong so that it can resist about 80 kinds of chemicals such as acid solvents, alkali solvents and the like.

Therefore, there is a problem in that bulletproof clothes, industrial gloves and the like manufactured using an ultra-high molecular weight polyethylene yarn are difficult to be dyed with commonly-known dyes because the ultra-high molecular weight polyethylene yarn cannot be easily dyed due to its high chemical resistance.

Further, there is a problem in that, even when an ultra-high molecular weight polyethylene yarn is coated with a paint containing pigment dispersed in a binder, the paint is separated because the adhesion therebetween is weak.

As a technology for enabling such a poorly-dyed ultra-high molecular weight polyethylene yarn to be dyed, Korea Patent Registration No. 10-0226043 discloses an ultra-high molecular weight polyethylene yarn, which is fabricated by binding a plurality of ultra-high molecular weight polyethylene filaments, and which is coated with a polyamide layer while being intruded into gaps in the ultra-high molecular weight polyethylene yarn, and a fishing line manufactured by dyeing the ultra-high molecular weight polyethylene yarn.

In the above technology, a polyamide layer is formed on the surface of an ultra-high molecular weight polyethylene yarn while being intruded into the gap of the ultra-high molecular weight polyethylene yarn, thus enabling the ultra-high molecular weight polyethylene yarn to be dyed.

However, such a chemical treatment method is problematic in that the production cost is increased because of a complicated process, and the physical properties of the polyethylene yarn are changed.

Thus, recently, when a glove or the like has been manufactured, the color and pattern thereof are formed by twisting an ultra-high molecular weight polyethylene yarn together with a colored fiber or by mix-spinning them.

However, this method is also problematic in that the structural strength is deteriorated because the ultra-high molecular weight polyethylene yarn and the colored fiber are mix-spun.

### DISCLOSURE

### Technical Problem

Accordingly, the present invention has been devised to solve the above-mentioned problems, and the present invention intends to provide a method of pretreating an ultra-high molecular weight polyethylene yarn before dyeing, wherein an ultra-high molecular weight polyethylene yarn can be dyed with a general dye by simple physical treatment, not by chemical treatment.

More concretely, the present invention intends to provide a method of pretreating an ultra-high molecular weight polyethylene yarn before dyeing, wherein a lubricant is applied onto the surface of the ultra-high molecular weight polyethylene yarn, and then the ultra-high molecular weight polyethylene yarn coated with the lubricant passes through a blowing tube, and simultaneously high-pressure air is supplied to the ultra-high molecular weight polyethylene yarn to form minute grooves on the surface thereof, so that the ultra-high molecular weight polyethylene yarn can be easily dyed.

Further, the present invention intends to provide a method of pretreating an ultra-high molecular weight polyethylene yarn before dyeing, wherein two pairs of rollers are disposed in front of and behind the blowing tube, respectively, and the rotational speed of the rear rollers and the rotational speed of the front rollers are controlled, so that the ultra-high molecular weight polyethylene yarn passes through the blowing tube with it being curved, with the result that compressed air is uniformly supplied to the surface of the ultra-high molecular weight polyethylene yarn.

Consequently, the present invention intends to provide a method of pretreating an ultra-high molecular weight polyethylene yarn before dyeing, wherein a dye easily adheres to the ultra-high molecular weight polyethylene yarn as a result of relatively simple physical treatment, and thus the ultra-high molecular weight polyethylene yarn can be dyed at low cost.

Furthermore, the present invention intends to provide a method of pretreating an ultra-high molecular weight polyethylene yarn before dyeing, wherein high-pressure air is applied to the ultra-high molecular weight polyethylene yarn, so that the ultra-high molecular weight polyethylene yarn becomes soft, thereby improving the flexibility of the ultra-high molecular weight polyethylene yarn.

### Technical Solution

In order to accomplish the above objects, an aspect of the present invention provides a method of pretreating an ultra-high molecular weight polyethylene yarn before dyeing, including the steps of: applying a lubricant to a surface of an ultra-high molecular weight polyethylene yarn; and passing the ultra-high molecular weight polyethylene yarn through a blowing tube and simultaneously blowing compressed air onto the surface of the ultra-high molecular weight polyethylene yarn.

Here, in the step of blowing the compressed air, a pair of front rollers may be disposed in front of the blowing tube, and a pair of rear roller may be disposed behind the blowing tube, and thus the ultra-high molecular weight polyethylene yarn may be introduced into the blowing tube by driving the front rollers and the, rear rollers and then be discharged to the outside.

Further, a plurality of air supply pipes may be connected to the blowing tube in different directions such that ultra-high molecular weight polyethylene yarn is blown by the compressed air from different angles.

Further, the blowing tube may have a diameter of 0.1˜5 mm.

Furthermore, the lubricant may be any one selected from water, a fiber softening agent, an antistatic agent and oil.

### Advantageous Effects

According to the present invention, an ultra-high molecular weight polyethylene yarn can be dyed with a general dye by simple physical treatment, not by chemical treatment.

More concretely, a lubricant is applied onto the surface of the ultra-high molecular weight polyethylene yarn, and then the ultra-high molecular weight polyethylene yarn coated with the lubricant passes through a blowing tube, and simultaneously high-pressure air is supplied to the ultra-high molecular weight polyethylene yarn to form minute grooves on the surface thereof, so that the ultra-high molecular weight polyethylene yarn can be easily dyed.

In this case, two pairs of rollers are disposed in front of and behind the blowing tube, respectively, and the rotational speed of the rear rollers and the rotational speed of the front rollers are controlled, so that the ultra-high molecular weight polyethylene yarn passes through the blowing tube with it being curved, with the result that compressed air is uniformly supplied to the surface of the ultra-high molecular weight polyethylene yarn.

Consequently, a dye easily adheres to the ultra-high molecular weight polyethylene yarn as a result of relatively simple physical treatment, and thus the ultra-high molecular weight polyethylene yarn can be dyed at low cost.

Further, high-pressure air is applied to the ultra-high molecular weight polyethylene yarn, so that the ultra-high molecular weight polyethylene yarn becomes soft, thereby improving the flexibility of the ultra-high molecular weight polyethylene yarn.

### DESCRIPTION OF DRAWINGS

FIG. 1 is a schematic view showing a method of pretreating an ultra-high molecular weight polyethylene yarn before dyeing.

FIG. 2 is a perspective view showing another blowing tube used in the present invention.

FIG. 3 is a schematic sectional view of an ultra-high molecular weight polyethylene yarn which was pretreated by the method and then dyed.

FIGS. 4 to 6 are photographs, each comparing an original ultra-high molecular weight polyethylene yarn with an ultra-high molecular weight polyethylene yarn on the surface of which there were formed a plurality of wedge-shaped minute grooves after which the yarn was dyed with pink, yellow and blue colors.

FIG. 7 is a photograph comparing an ultra-high molecular weight polyethylene yarn on the surface thereof of which there was not formed a plurality of wedge-shaped minute grooves and which was dyed with a deep blue color with an ultra-high molecular weight polyethylene yarn on the surface of which there were formed a plurality of wedge-shaped minute grooves and which was then dyed with the same color.

FIG. 8 is a photograph showing gloves fabricated by dyeing the ultra-high molecular weight polyethylene yarn which was pretreated by the method of the present invention.

### DESCRIPTION OF THE REFERENCE NUMERALS IN THE DRAWINGS

10: blowing tube

11: expansion part

20: air supply pipe

30: lubricant supply pipe

40: rear rollers

50: front rollers

60: ultra-high molecular weight polyethylene yarn

70: dye layer

### BEST MODE

When ultra-high molecular weight polyethylene is ultradrawn in one direction, its mechanical properties become excellent because the degree of orientation of polymer chains becomes high.

This ultra-high molecular weight polyethylene fiber has high specific strength (strength per unit weight) compared to that of a commercially available high-functional fiber, such as an aramid fiber (Kevlar), a carbon fiber, a special glass fiber, a born fiber or the like, and has similar specific elasticity to that of a highly-elastic carbon fiber. Therefore, the ultra-high molecular weight polyethylene fiber is increasingly used in fields requiring high strength and low usable temperature.

As products requiring high strength, there are military goods, such as bulletproof clothes, helmets, etc., and industrial ropes which are under a high load.

When the ultra-high molecular weight polyethylene fiber is fabricated by low-temperature extrusion, it can be widely used for medical structural materials or industrial precision parts.

Such ultra-high molecular weight polyethylene fiber is not used as a surface material for expressing colors of clothes, gloves or the like because it cannot be easily dyed due to its high chemical resistance.

Thus, the present inventors have done research in order to solve the above problem. As a result, they found that, when compressed air is blown onto the ultra-high molecular weight polyethylene fiber, a plurality of minute grooves is formed on the surface thereof as if it had been scratched, and thus a dye easily adheres to the surface thereof.

Based on the finding, the present invention was completed. Hereinafter, a method of pretreating an ultra-high molecular weight polyethylene yarn before dyeing according to the present invention will be described in more detail.

The method of pretreating an ultra-high molecular weight polyethylene yarn before dyeing according to the present invention includes the steps of: applying a lubricant to the surface of an ultra-high molecular weight polyethylene yarn 60; and blowing compressed air onto the surface of the ultra-high molecular weight polyethylene yarn 60.

As described above, the present inventors found that, when compressed air is blown onto the ultra-high molecular weight polyethylene yarn 60 and the yarn is then coated with a dye, the dye easily adheres to the surface of the ultra-high molecular weight polyethylene yarn 60.

However, from the results of several tests carried out by the present inventors, they found that, while compressed air is blown onto the ultra-high molecular weight polyethylene yarn 60, the ultra-high molecular weight polyethylene yarn 60 was entangled and twisted, and thus it is required to untangle the ultra-high molecular weight polyethylene yarn 60.

Therefore, the step of applying a lubricant to the surface of the ultra-high molecular weight polyethylene yarn 60 is performed in order to prevent the ultra-high molecular weight polyethylene yarn 60 from being entangled by applying the lubricant onto the surface of the ultra-high molecular weight polyethylene yarn 60 before compressed air is blown onto the ultra-high molecular weight polyethylene yarn 60.

Water, oil or the like may be generally used as the lubricant. Further, a fiber softening agent, an antistatic agent or the like may be used independently or in combination with water or oil.

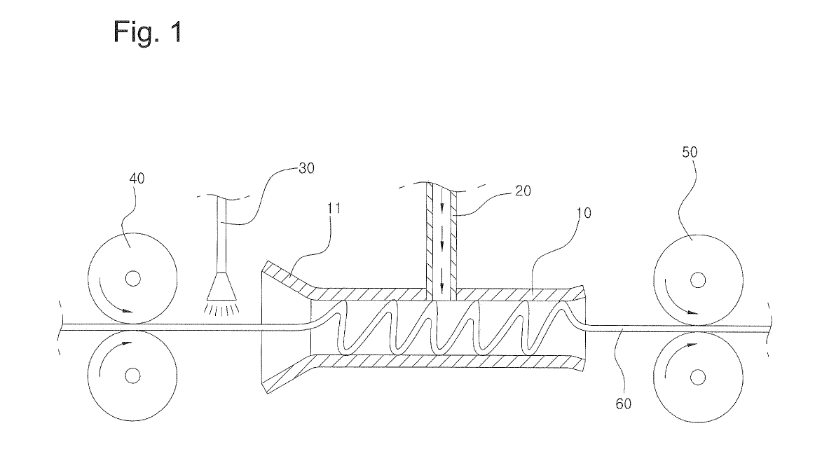

As shown in FIG. 1, the lubricant is supplied by a nozzle provided at the front end of a lubricant supply pipe 30 disposed in front of the blowing tube 10.

In another lubricant supply method (not shown), since the lubricant supply pipe 30 is connected to one side of an air supply pipe 20, the lubricant may be supplied to the ultra-high molecular weight polyethylene yarn 60 together with the air.

In the step of blowing compressed air onto the surface of the ultra-high molecular weight polyethylene yarn 60, as shown in FIG. 1, the bowing tube 10, one side of which is connected with the air supply pipe 20 connected to a compressor, is configured such that ultra-high molecular weight polyethylene yarn 60 passes through the inside of the blowing tube 10, and simultaneously compressed air is supplied to the inside of the blowing tube by the air supply pipe 20, thus blowing the ultra-high molecular weight polyethylene yarn 60.

A general industrial compressor may be used as the compressor. The compressor supplies compressed air to the ultra-high molecular weight polyethylene yarn 60 through the air supply pipe 20 having an inner diameter of 0.1˜1.5 mm or through the air supply 20 including an end which has an inner diameter of 0.1˜1.5 mm.

In this case, when compressed air is supplied in only one direction, only one side of the ultra-high molecular weight polyethylene yarn 60 is provided with minute grooves, and thus a dye does not easily adhere to the other side thereof.

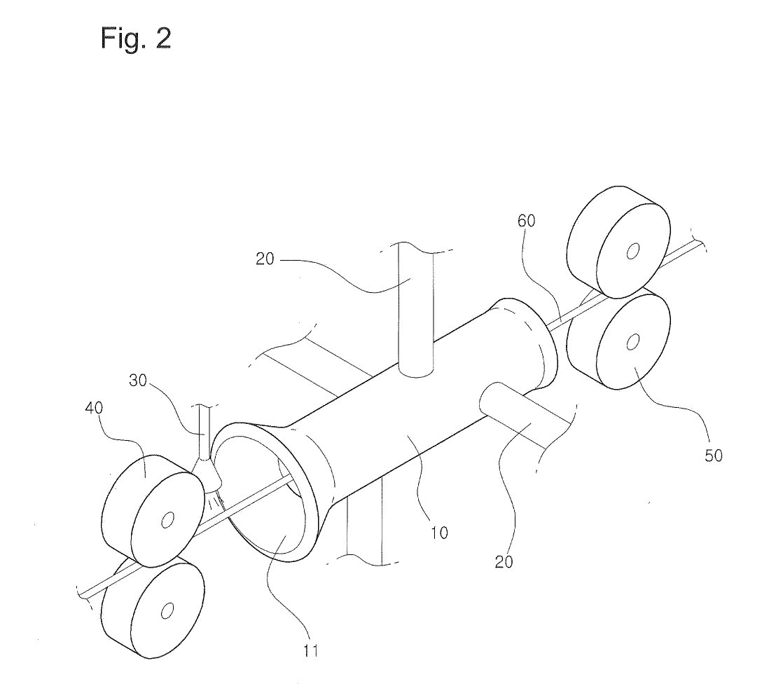

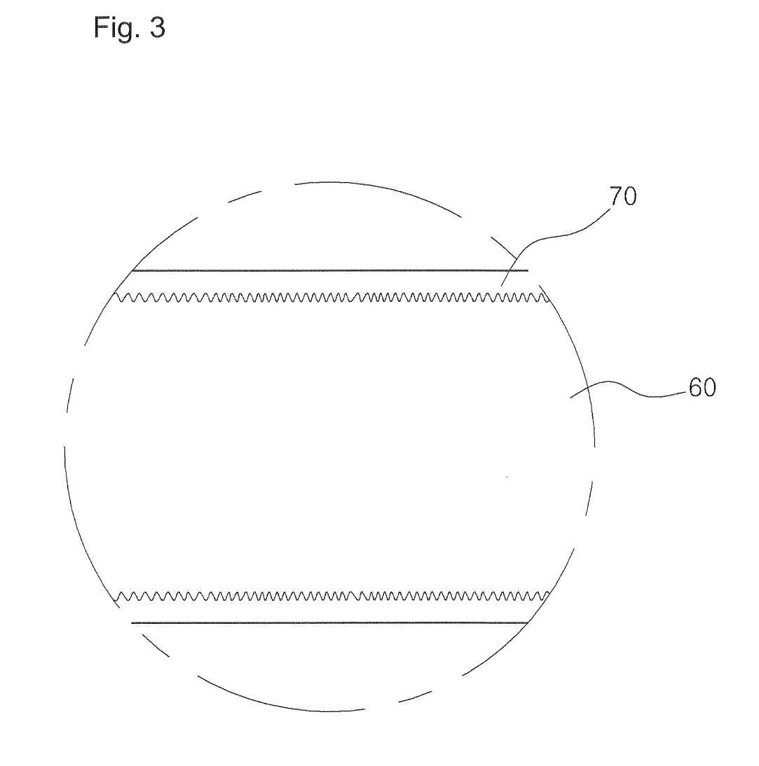

Therefore, in order to entirely dye the surface of the ultra-high molecular weight polyethylene yarn 60, as shown in FIG. 2, several air supply pipes 20 are connected to the upper, lower, left and right sides of the blowing tube 20, thus allowing compressed air to be blown onto the entire surface of the ultra-high molecular weight polyethylene yarn 60.

As such, when compressed air is uniformly supplied to the entire surface of the ultra-high molecular weight polyethylene yarn 60 by the air supply pipes 20 connected to the upper, lower, left and right sides of the blowing tube 20, minute grooves are uniformly formed on the entire surface of the ultra-high molecular weight polyethylene yarn 60, thus enabling the ultra-high molecular weight polyethylene yarn 60 to be dyed.

However, when several air supply pipes 20 are connected to the blowing tube 20, there is a problem in that the production cost is reduced because several compressors must be provided.

In order to solve the above problem, as shown in FIG. 1, the ultra-high molecular weight polyethylene yarn 60 passing through the blowing tube moves zigzag, and only one or two air supply pipes 20 are connected to the blowing tube 20 to provide a minimum of air supply pipes 20, thus uniformly forming minute grooves on the surface of the ultra-high molecular weight polyethylene yarn 60.

As such, in order for the ultra-high molecular weight polyethylene yarn 60 to have movability in the blowing tube 10, it is preferred that the inner diameter of the blowing tube 10 be 0.1˜5 mm.

When the inner diameter of the blowing tube is more than 5 mm, the movability of the ultra-high molecular weight polyethylene yarn 60 in the blowing tube 10 is excessively increased, so that the ultra-high molecular weight polyethylene yarn 60 can be entangled even though a lubricant is applied to the surface thereof. Further, when the inner diameter thereof is less than 0.1 mm, the movability of the ultra-high molecular weight polyethylene yarn 60 in the blowing tube 10 is excessively decreased, so that minute grooves are not uniformly formed over the entire surface of the ultra-high molecular weight polyethylene yarn 60, thereby reducing a ratio of the dyed surface to the total surface thereof.

As described above, when the inner diameter of the blowing tube 10 is larger than the outer diameter of the ultra-high molecular weight polyethylene yarn 60, compressed air is introduced into the blowing tube 10, and simultaneously the compressed air blows the ultra-high molecular weight polyethylene yarn 60, so that the ultra-high molecular weight polyethylene yarn 60 naturally moves zigzag.

Meanwhile, in order to enable the ultra-high molecular weight polyethylene yarn 60 to naturally move zigzag in the blowing tube 10, rollers may be respectively disposed at the front and rear of the blowing tube 10 such that the ultra-high molecular weight polyethylene yarn 60 is pulled by the rollers.

For this purpose, as shown in FIGS. 1 and 2, a pair of front rollers 50 is disposed in front of the blowing tube 10, and a pair of rear rollers 40 is disposed behind the blowing tube, and thus the ultra-high molecular weight polyethylene yarn 60 is introduced into the blowing tube 10 by driving the front rollers 50 and the rear rollers 40 and then discharged to the outside.

In this case, the rotational speeds of the front rollers 50 and the rear rollers 40 are normally maintained constant. However, when the rotational speed of the rear rollers 40 is rapid and the rotational speed of the front rollers 50 is slow, the ultra-high molecular weight polyethylene yarn 60 can move zigzag in the blowing tube 10.

Moreover, as shown in FIGS. 1 and 2, since the rear part of the blowing tube is provided with an expansion part having a large diameter, the ultra-high molecular weight polyethylene yarn 60 can be easily introduced into the blowing tube 10.

Meanwhile, when the surface of the ultra-high molecular weight polyethylene yarn 60 pretreated by the above method is magnified and then observed, it can be seen that a plurality of wedge-shaped minute grooves are formed on the surface thereof.

That is, since the surface of the ultra-high molecular weight polyethylene yarn 60 is blown by compressed air, wedge-shaped minute grooves are continuously formed on the surface thereof. When this ultra-high molecular weight polyethylene yarn 60 provided with the wedge-shaped minute grooves is observed with the naked eye, it is seen as being snow-white. These wedge-shape minute grooves serve to greatly increase the surface area of the ultra-high molecular weight polyethylene yarn and to prevent a dye from detaching itself from the surface thereof by fixing the dye.

In this case, the method of forming the wedge-shaped minute grooves on the surface of the ultra-high molecular weight polyethylene yarn 60 is said to be performed by blowing compressed air onto the ultra-high molecular weight polyethylene yarn 60, but this is not limited thereto. For example, the wedge-shaped minute grooves may be formed by blowing the ultra-high molecular weight polyethylene yarn 60 with water or sand. In addition, the wedge-shaped minute grooves may be formed by other methods.

Meanwhile, as the size of the wedge-shaped minute grooves changes, the number of the wedge-shaped minute grooves formed per unit surface area of the ultra-high molecular weight polyethylene yarn 60 also changes, thus changing the physical properties thereof. The number of the wedge-shaped minute grooves per unit surface area (1 mm²) of the ultra-high molecular weight polyethylene yarn 60 may be 100/mm²˜10000/mm², and preferably 3000/mm²˜4000/mm².

In this case, when the number of wedge-shaped minute grooves per unit surface area (1 mm²) of the ultra-high molecular weight polyethylene yarn 60 is decreased because the size thereof is large, the surface of the ultra-high molecular weight polyethylene yarn 60 becomes soft and more easily dyed. However, when the number of the wedge-shaped minute grooves per unit surface area (1 mm²) of the ultra-high molecular weight polyethylene yarn 60 is increased because the size thereof is small, the surface of the ultra-high molecular weight polyethylene yarn 60 is maintained smooth. Therefore, when the number of the wedge-shaped minute grooves is less than 100/mm², the size of the wedge-shaped minute grooves is excessively large, and thus the dyeing uniformity of the ultra-high molecular weight polyethylene yarn 60 becomes low. Further, when the number of the wedge-shaped minute grooves is more than 10000/mm², the size of the wedge-shaped minute grooves is excessively small, and thus the dyeing affinity of the ultra-high molecular weight polyethylene yarn 60 is slightly increased, which is inefficient.

### MODE FOR INVENTION

### TEST EXAMPLE 1

In order to ascertain whether the dyeing affinity of an ultra-high molecular weight polyethylene yarn provided at the surface thereof with wedge-shaped minute grooves was improved to some degree, the dyeing affinities thereof were observed and compared as follows.

First, four samples of an ultra-high molecular weight polyethylene yarn were provided before dyeing. Subsequently, wedge-shaped minute grooves were formed on samples 1, 2 and 3 by blowing compressed air onto the yarn, and then samples 1, 2 and 3 were respectively dyed with high-pressure dispersive dyes of pink, yellow and blue colors.

Meanwhile, sample 4 was dyed with a high-pressure dispersive dye of a deep blue color without blowing compressed air thereto.

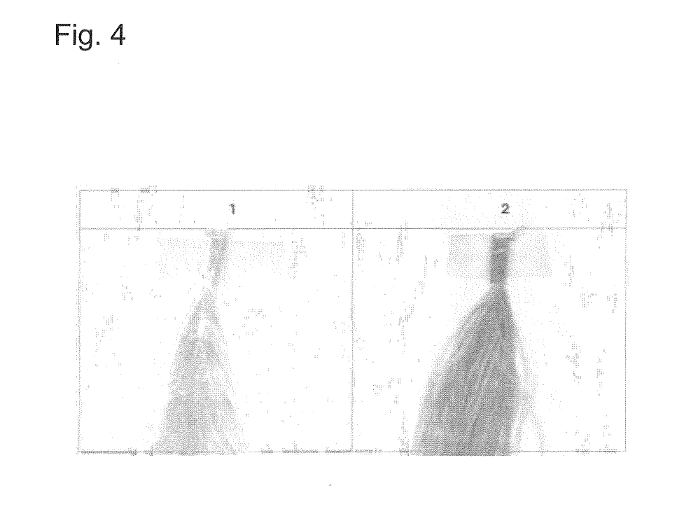

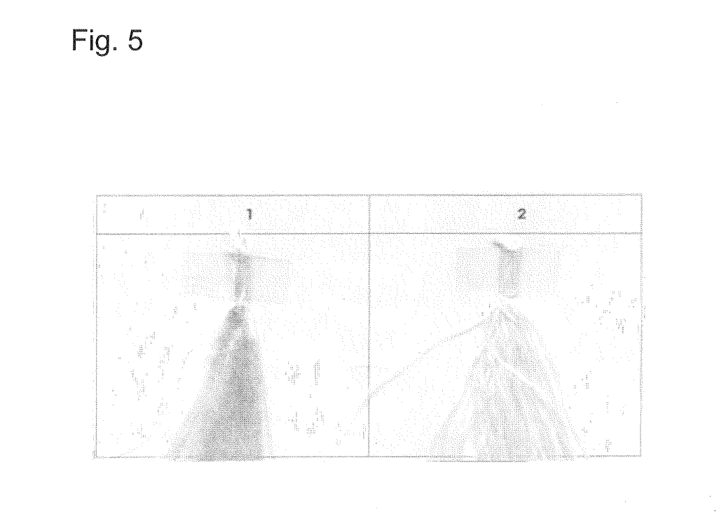

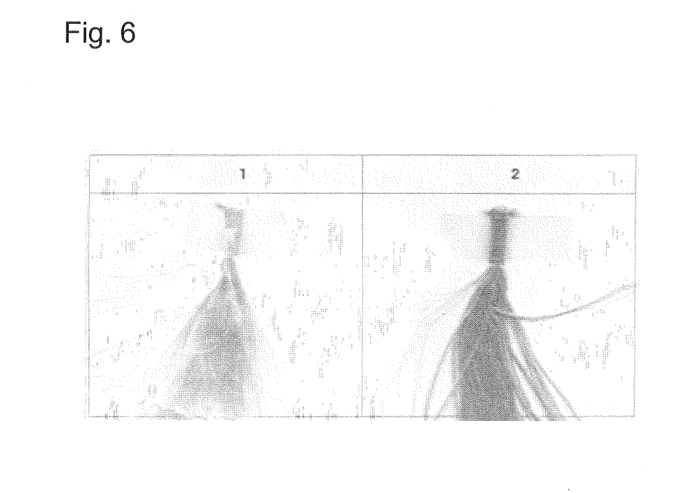

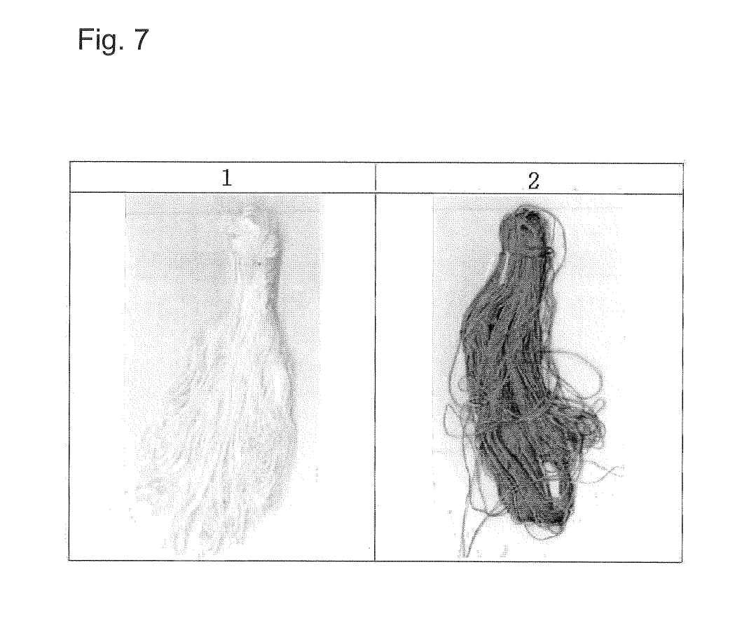

The results thereof are shown in FIGS. 4 to 7, and are given in Table 1 below. Here, FIGS. 4 to 6 are photographs, each comparing an original ultra-high molecular weight polyethylene yarn with an ultra-high molecular weight polyethylene yarn on the surface of which there had been formed a plurality of wedge-shaped minute grooves and then dyed, and FIG. 7 is a photograph comparing an ultra-high molecular weight polyethylene yarn on the surface of which there had not been formed a plurality of wedge-shaped minute grooves and then dyed with an ultra-high molecular weight polyethylene yarn on the surface of which a plurality of wedge-shaped minute grooves had been formed and then dyed.

TABLE 1

| | Colors of dye | Dyed state |
|---|---|---|
| Sample 1 | pink | clear |
| Sample 2 | yellow | clear |
| Sample 3 | blue | clear |
| Sample 4 | deep blue | hardly dyed |

From Table 1 above, it can be ascertained that the dyeing affinities of samples 1 to 3, on the surfaces of which wedge-shaped minute grooves were formed and then dyed, are higher than that of sample 4, which was dyed without blowing compressed air thereonto. Consequently, it can be ascertained that the dyeing affinities of samples 1 to 3 were improved.

### TEST EXAMPLE 2

Meanwhile, in order to ascertain whether dyes were discolored to some degree after the dyed samples had been washed, samples were respectively washed at 60° C. for 20 minutes using a detergent according to the standard of American Association of Textile Chemists and Colorists (AATCC), and the results thereof are given Table 2 below.

TABLE 2

| | Colors of dye | Degree of discoloration |
|---|---|---|
| Sample 1 | pink | not discolored |
| Sample 2 | yellow | not discolored |
| Sample 3 | blue | not discolored |
| Sample 4 | deep blue | dyeing affinity reduced |
| | | by 50% |

From Table above, it can be ascertained that, since the dyeing affinity of the ultra-high molecular weight polyethylene yarn provided with wedge-shaped minute grooves is higher than that of the generally-dyed ultra-high molecular weight polyethylene yarn, discoloration did not occur, from which it could be concluded that the dyed ultra-high molecular weight polyethylene yarn would stay dyed for a long period of time.

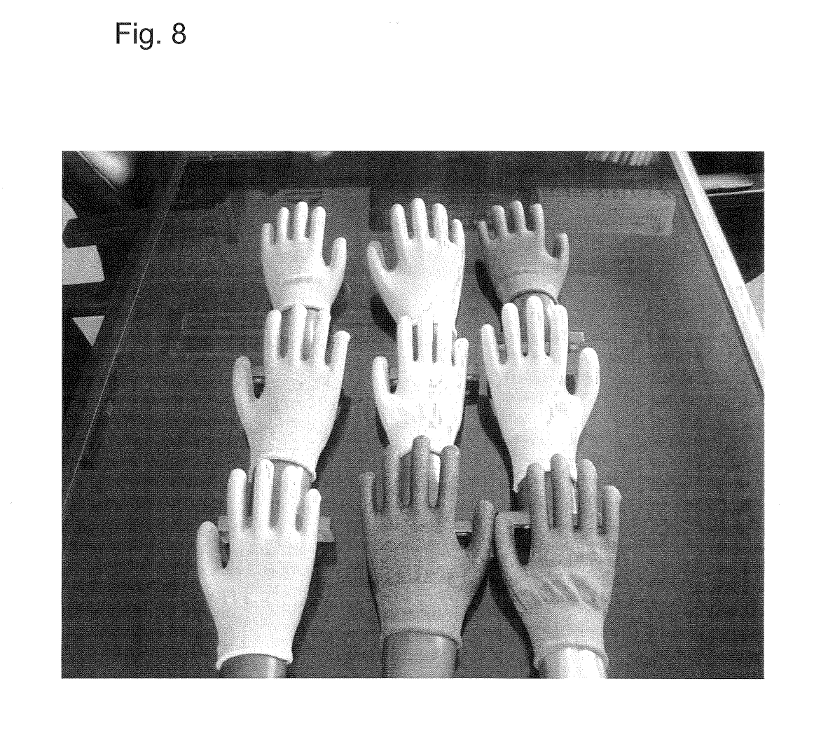

FIG. 8 is a photograph showing gloves fabricated by dyeing the ultra-high molecular weight polyethylene yarn which was pretreated by the method of the present invention. As shown in FIG. 8, it can be ascertained that the gloves were very clearly dyed.

1. A method of pretreating an ultra-high molecular weight polyethylene yarn before dyeing, comprising the step of:
passing an ultra-high molecular weight polyethylene yarn through a blowing tube and simultaneously blowing compressed air onto a surface of the ultra-high molecular weight polyethylene yarn.

2. The method according to claim 1, wherein conveying units for controlling the transfer of the ultra-high molecular weight polyethylene yarn are respectively disposed in front of and behind the blow tube to move the ultra-high molecular weight polyethylene yarn zigzag.

3. The method according to claim 1, wherein compressed air is supplied to the blowing tube by a plurality of air supply pipes connected to the blowing tube in different directions such that ultra-high molecular weight polyethylene yarn is blown by the compressed air from different angles.

4. The method according to claim 1, wherein the blowing tube has a diameter of 0.1˜5 mm.

5. The method according to claim 1, further comprising the step of: applying a lubricant onto the surface of the ultra-high molecular weight polyethylene yarn, before the step of blowing the compressed air.

6. The method according to claim 5, wherein the lubricant is any one selected from water, a fiber softening agent, an antistatic agent, and oil.

7. An ultra-high molecular weight polyethylene yarn, comprising wedge-shaped minute grooves formed on the surface thereof.

8. The ultra-high molecular weight polyethylene yarn according to claim 7, wherein the number of the wedge-shaped minute grooves per unit surface area of the ultra-high molecular weight polyethylene yarn is 100/mm²˜10000/mm².
